(19) United States
(12) Patent Application Publication
(10) Pub. No.: US 2026/0196792 A1
(43) Pub. Date: Jul. 9, 2026

(54) COUNTERPROPAGATING MULTICORE OPTICAL FIBER AMPLIFIER ASSEMBLY

(71) Applicant: SUBCOM, LLC, Eatontown, NJ (US)

(72) Inventor: Andrew Meigs, Durham, CT (US)

(73) Assignee: SUBCOM, LLC, Eatontown, NJ (US)

(21) Appl. No.: 19/009,259

(22) Filed: Jan. 3, 2025

(51) Int. Cl. H01S 3/00; G02B 3/00; G02B 27/28; H01S 3/067

(52) U.S. Cl. CPC H01S 3/0064; G02B 27/286; H01S 3/06737; G02B 3/0087

(57) ABSTRACT

An optical isolator for a fiber optic system. The optical isolator may include a polarization processing assembly, comprising a first polarization processing element and a second polarization processing element, a non-reciprocal optical element, disposed between the first polarization processing element and the second polarization processing element, and a reciprocal optical element assembly. The reciprocal optical element assembly may include a first reciprocal element, disposed between the non-reciprocal optical element and the first polarization processing element; a second reciprocal element, disposed between the non-reciprocal optical element and the second polarization processing element; and a patterning element to selectively direct light through the optical isolator according to a polarization of the light.

### BACKGROUND

### Related Applications

### Field

Embodiments of the present disclosure relate to the field of optical communication systems. In particular, the present disclosure relates to techniques for improved fiber amplifiers for repeaters.

### Discussion of Related Art

A recent advancement in the fiber optic industry is the creation of optical fibers having not one single-mode core, but rather, multiple single-mode cores (MCF), which cores may be arranged in a variety of configurations: 1×2, 2×2, 1×4, 7 in a hexagonal pattern, etc. To incorporate these multi-core fibers in a communication system, typically “fan-in” and “fan-out” (FIFO) structures may be used to connect multiple single-mode fibers with the multi-core fiber. These FIFO structures allow the MCF to be used with conventional single-mode components, such as isolators, amplifiers and filters. There are several shortcomings of this approach: the difficulty in fabrication of the fan-in and fan-out components, the length of the fan-in and fan-out structures, the number of single mode components, the volume of the components, etc. as well as the complexity of preservation the ordering/pairing of the cores of the multi-core fibers.

Ideally, because of crosstalk considerations, the MCF would be used as a bidirectional device, meaning that the MCF would have n pairs of cores, where each pair of cores transmits traffic in opposing directions, so that crosstalk between adjacent cores would have minimal impact. A difficulty with this approach is that known isolators when used with a bidirectional MCF would pass traffic in one of the two channels and inherently block transmission in the other channel.

It is with respect to these and other considerations that the present disclosure is provided.

### Brief Summary

In one embodiment, an optical isolator for a fiber optic system is provided. The optical isolator may include a polarization processing assembly, comprising a first polarization processing element and a second polarization processing element, a non-reciprocal optical element, disposed between the first polarization processing element and the second polarization processing element, and a reciprocal optical element. The reciprocal optical element assembly may include a first reciprocal element, disposed between the non-reciprocal optical element and the first polarization processing element; a second reciprocal element, disposed between the non-reciprocal optical element and the second polarization processing element; and a patterning element to selectively direct light through the optical isolator according to a polarization of the light.

In another embodiment, a fiber amplifier may include a pump source, to generate a pump radiation; a fiber assembly, comprising a first input multi-core fiber and a first output multi-core fiber, disposed along a first optical path, and a second input fiber and a second output fiber, disposed along a second optical path. The fiber amplifier may further include a multi-core fiber amplifier assembly, arranged along the first path and the second path, and disposed between the input multi-core fiber and the first output multi-core fiber, and further disposed between the second input fiber and the second output fiber. The multi-core fiber amplifier assembly may include a plurality of optical isolators, wherein a given optical isolator of the plurality of optical isolators comprises: a non-reciprocal optical element; a first reciprocal element, disposed on a first side of the non-reciprocal optical element; a second reciprocal element, disposed on a first side of the non-reciprocal optical element; and a patterning element to selectively direct light through the given optical isolator according to a polarization of the light.

### BRIEF DESCRIPTION OF THE DRAWINGS

FIG. 1A depicts an optical isolator, according to embodiments of the disclosure;

FIG. 1B shows an example of a variant of the optical isolator of FIG. 1A in operation;

FIG. 1C shows an example of a variant of a halfwave plate, according to some embodiments;

FIG. 1D depicts an optical isolator, according to embodiments of the disclosure;

FIG. 1E shows an example of a variant of the optical isolator of FIG. 1D in operation;

FIG. 2 shows a multicore fiber amplifier assembly, according to embodiments of the disclosure;

FIG. 3A shows another multicore fiber amplifier assembly, according to embodiments of the disclosure;

FIG. 3B depicts details of an isolator gain flattening filter, according to some embodiments;

FIG. 3C depicts the isolator-gain flattening filter of FIG. 3B in side view;

FIG. 4 shows a further multicore fiber amplifier assembly, according to embodiments of the disclosure;

FIG. 5 shows an additional multicore fiber amplifier assembly, according to embodiments of the disclosure; and

FIG. 6 presents one embodiment of an optical communications system.

### DESCRIPTION OF EMBODIMENTS

The present embodiments will now be described more fully hereinafter with reference to the accompanying drawings, in which exemplary embodiments are shown. The scope of the embodiments should not be construed as limited to the embodiments set forth herein. Rather, these embodiments are provided so that this disclosure will be thorough and complete, and will fully convey the scope of the embodiments to those skilled in the art. In the drawings, like numbers refer to like elements throughout.

Before detailing specific embodiments with respect to the figures, general features with respect to the embodiments will be reviewed. In accordance with embodiments of the disclosure, a novel optical isolator component is provided for fiber optic systems, such as for use in a fiber amplifier. As detailed in the embodiments to follow, the novel optical isolator may be integrated into multi-core fiber amplifier to permit light transmission in both directions for a given pair of cores of a multi-core fiber assembly.

By way of reference, fiber optic isolators can be constructed as polarization dependent or polarization independent. Both of these type of isolators may employ a polarization processing element at the input side and the output side of an isolator. A polarization dependent optical isolator may use two linear polarizers as the polarization processing elements, a non-reciprocal optical element and a reciprocal optical element. The operation is as follows: incoming light is linear polarized by an input linear polarizer (for instance vertically polarized). The light then travels through a non-reciprocal optical element, where the plane of the polarization is rotated typically by 45 degrees. The light then travels through the reciprocal optical element, where the light is rotated another 45 degrees for a total angular rotation of 90 degrees or horizontally polarized. The light then travels through the second linear polarizer, whose plane of polarization is rotated by 90 degrees to the first polarizer. Light traveling in the opposite direction is first polarized in the horizontal plane. The reciprocal optical element will rotate the plane of polarization by −45 degrees. The plane of polarization is now at 45 degrees. As the light traverses the non-reciprocal element, the light undergoes a +45-degree rotation. The light exiting the non-reciprocal optical element will now by horizontally polarized. This light will be blocked by the first linear polarizer. In this way, the configuration of optical elements allows light to travel just in one direction. There are many situations where the first polarizer is unnecessary, for instance, with a polarized laser or polarization maintaining fiber, because the input light is already known to be plane polarized. The most common non-reciprocal optical element is a Faraday rotator, a special crystal within a strong magnetic field. The source of non-reciprocal nature comes about because the light (an electric field) is traveling either in the direction of the magnetic field or against the direction.

For simplicity, we will refer to the non-reciprocal optical element as a Faraday rotator for the remainder of this disclosure, although in other embodiments other non-reciprocal optical elements are possible. Similarly, the reciprocal optical element used in the present embodiments may be a halfwave plate, and is generally depicted in the figures to follow. But in other embodiments other components for rotating the plane of polarization by 45 degrees, for instance, using a mirror configuration. For simplicity, we will refer to the reciprocal optical element as a halfwave plate.

To make a polarization independent optical isolator, some method is required to separate the vertical and horizontal polarizations and treat each polarization with its “own” polarization dependent isolator. Typically, in known systems a set of birefringent crystal are used as the polarization processing elements in order to separate and recombine the polarizations. In a birefringent crystal, vertical polarized light travels with a different speed (index of refraction) than the horizontal polarized light. The two indices are referred to as the ordinary and extra-ordinary index of refraction. With an appropriately cut crystal, the vertical and horizontal polarized light have different amounts of optical “walk-off” and therefore emerge at spatially distinct positions on the exit face of the crystal.

To construct a polarization independent optical isolator, the input and output linear polarizers are replaced with input and output birefringent crystals that act as the polarization processing elements. Input light is spatially separated into its two orthogonal polarization components. The two components travel through the Faraday Rotator and halfwave plate as before. To recombine the two beams, a second birefringent crystal is used. Since the plane of polarization has been rotated by 90 degrees, the beam that walked further in the first crystal will walk less in the second and vice-versa, with the net result that the beams combine and can exit together. Light traveling in the opposing direction won't be rotated by 90 degrees, meaning that the opposing light will either not walk off or exhibit twice the walk-off. The provision of a simple beam-block (iris) will stop these components, resulting in the desired isolator operation.

To make a fiber optic isolator, a lens is used to collimate the light and then use “bulk” optics to implement the isolator as described above. A second lens is used to focus the collimated light back into the exit fiber. Typically, the lens used to accomplish this task are gradient index elements, such as Gradient Index rods or GRINs, because the entrance and exit faces of such components do not need to be curved. Further, in the case of the polarization independent isolator, an explicit beam block is not necessary, since the unwanted components will not be focused on the core of the fiber, and will naturally be attenuated within the fiber.

As one of ordinary skill in the art will know, there are multiple ways of designing an optical isolator. The light need not be linearly polarized. Circular polarized light can also be used. The halfwave plate can be constructed out of a thinly cut crystal. Alternatively, liquid crystals or thin-film stacks could be employed.

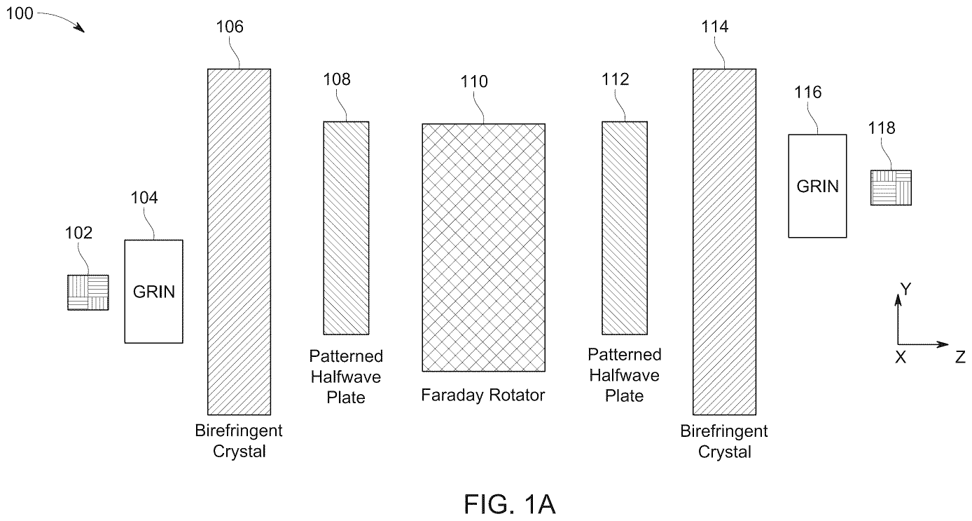

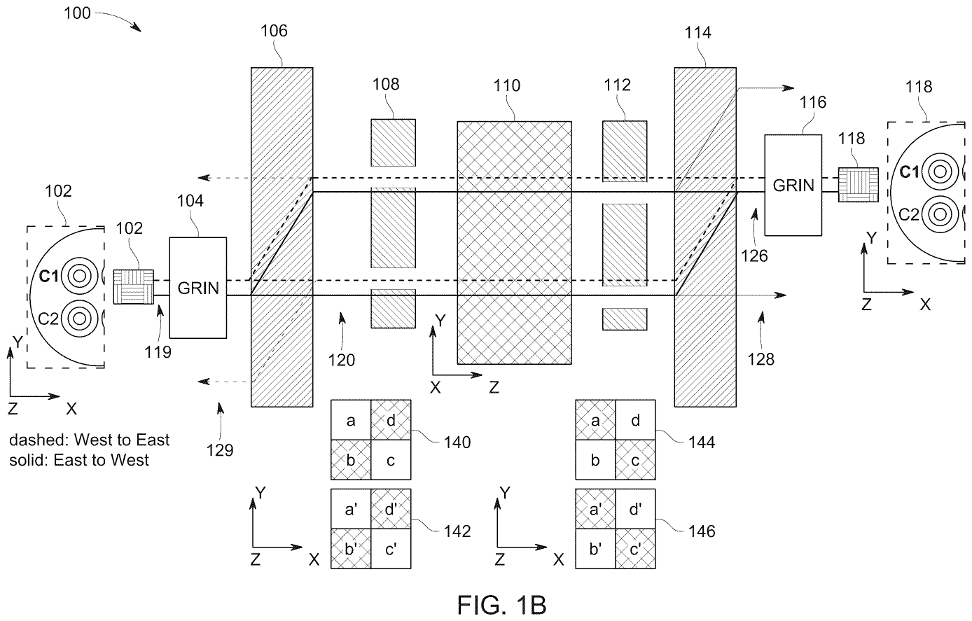

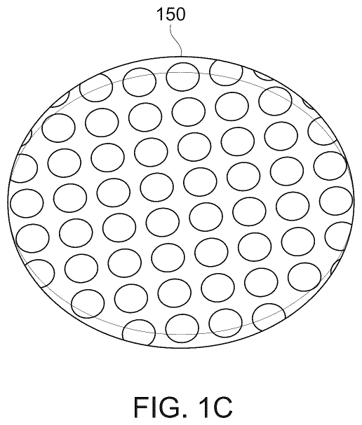

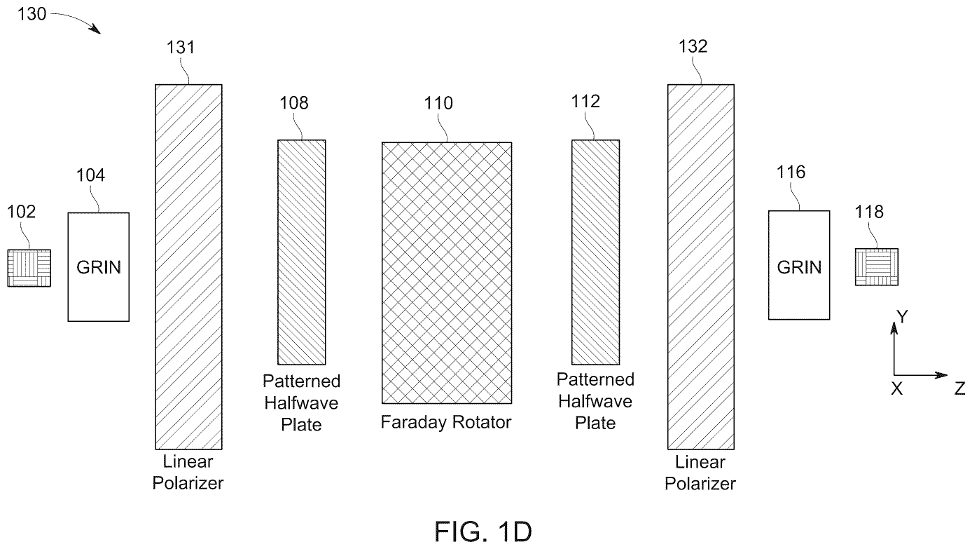

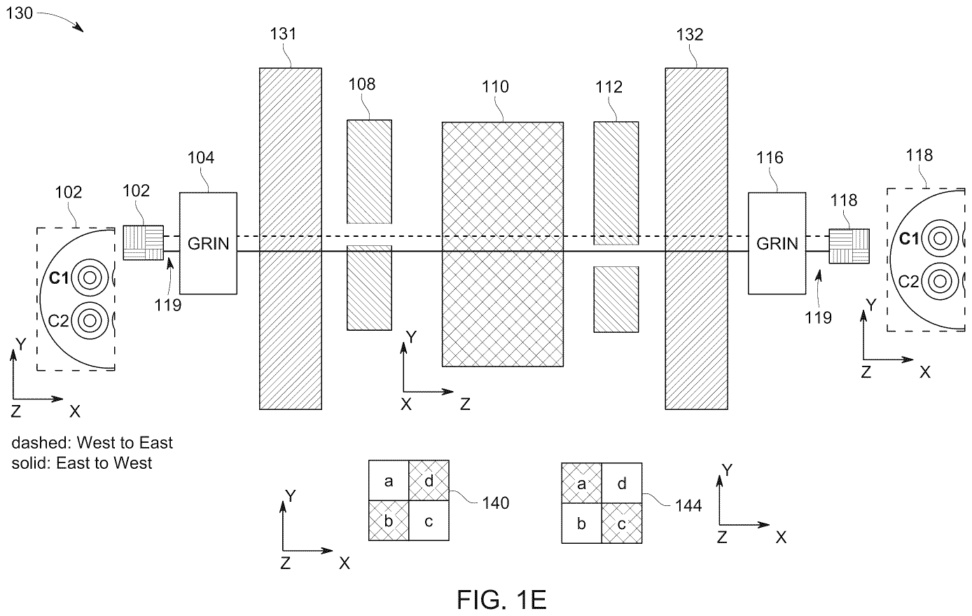

FIG. 1A depicts a polarization independent optical isolator, shown as optical isolator 100, according to embodiments of the disclosure. According to various embodiments, the optical isolator 100 may be suitable for operation is an assembly, including a fiber amplifier, where coupling is to take place between input and output fibers that are arranged along a given transmission path, as well as coupling to an external pump source for amplifying an optical signal being conducted along the transmission path. The optical isolator 100 may include a birefringent crystal assembly, including a first crystal 106 and a second crystal 114. These crystals may be arranged as birefringent crystals as known in the art. The optical isolator 100 may further include a non-reciprocal optical element, such as a Faraday rotator element 110, disposed between the first crystal 106 and the second crystal 114, as well a halfwave plate assembly that may be considered to be an example of a reciprocal optical element assembly. The halfwave plate assembly is arranged on opposite sides of the Faraday rotator element 110. The halfwave plate assembly may include a first halfwave plate 108, disposed between the Faraday rotator element 110 and the first crystal 106, and a second halfwave plate 112, disposed between the Faraday rotator element 110 and the second crystal 114. According to embodiments of the disclosure, the optical isolator 100, as well as similar isolators, may include; and a patterning element to selectively direct light through the optical isolator 100 according to a polarization of the light. As detailed in embodiments to follow, the patterning element of the optical isolator 100 will facilitate bi-directional functionality of a multi-core fiber (MCF) apparatus, such as a MCF amplifier, while providing isolation from back-reflections.

In the embodiment specifically illustrated in FIG. 1A, the first halfwave plate 108 and the second halfwave plate 112 may be patterned half-waveplates, where examples of patterning are explained further below.

Turning to FIG. 1B there is shown an example of a variant of the optical isolator 100 of FIG. 1A in operation. In this example, an input fiber 102 is shown, as well as an output fiber 118. According to various embodiments of the disclosure, the input fiber 102, and the output fiber 118 may be multi-core fibers arranged with n pairs of cores, where n is any suitable integer.

The optical isolator 100 may be considered to include components disposed between the input fiber 102 and output fiber 118. As such, the optical isolator may include a first graded-index lens or GRIN 104 and a second GRIN 116. When an input light signal 119 enters from the lower left of the figure, this input light signal is conducted to the right through GRIN 104, first crystal 106, first halfwave plate 108, Faraday rotator element 110, second halfwave plate 112, second crystal 114, and second GRIN 116, exiting into output fiber 118. In various embodiments, patterning of the first halfwave plate 108 and the second halfwave plate 112 is arranged so that bidirectional transmission of light takes place through a given pair of cores, while providing isolation from back-reflections. In particular embodiments, wherein the a halfwave plate may include wavelength filter, arranged to introduce a pump source into an optical path of the optical isolator.

For the purposes of clarity of explanation, FIG. 1c depicts one configuration for patterning of the first halfwave plate 108 and the second halfwave plate 112 in accordance with the present disclosure. In this example, the input fiber 102 and the output fiber 118 may be assumed to have two pairs of cores, where bidirectional transmission is needed in each of the pairs of cores. The lower portion of FIG. 1 depict an end view of a pattern arrangement 140 and pattern arrangement 142, which components may be integrated along the main face of the first halfwave plate 108, meaning as viewed in the X-Y plane of the Cartesian coordinate system shown. Likewise, an end view of a pattern arrangement 144 and pattern arrangement 146 are shown, which components may be integrated along the main face of the second halfwave plate 112.

In the particular example shown in FIG. 1B, the pattern arrangements 140, 142, 144, and 146 are arranged as four sub-elements in a quadrant that from a checkerboard pattern. This type of patterning for the first halfwave plate 108 and the second halfwave plate 112 may be suitable for coupling to an input fiber (and/or output fiber) having two pairs of cores that are arranged in a similar quadrant pattern along a cross-sectional face of the input fiber. An example of a two-core-pair fiber variant for input fiber 102 is also shown in the lower left of the FIG. 1B. More generally, according to embodiments of the disclosure, the patterning of the pattern arrangements, such as pattern arrangements 140, 142, 144, and 146 are set to match the geometry of the corresponding input fiber, or output fiber. Thus, in the example of FIG. 1B the quadrant pattern of the pattern arrangements 140, 142, 144, and 146 would be used in conjunction with the input fiber 102 when that fiber has a similar quadrant pattern as shown. A 3×3 multi-core input fiber would be suitably coupled to a waveplate having a stack of two three by three pattern arrangement, and so forth.

A characteristic of the pattern arrangements 140, 142, 144, and 146, is that adjacent sub-elements in any given pattern arrangement differ from one another. In one convention, the lighter sub-elements correspond to regions where no half-wave plate element exists. Thus, the pattern arrangements 140, 142, 144, and 146, represent patterns of alternating regions where a half-wave plate material is absent or present. In the scenario of FIG. 1B, the operation of these elements would be as follows. Consider light in a core C1 in the upper left in the input fiber 102 (corresponding to sub-element a) traveling to the right. This light through core C1 would be collimated by the GRIN 104. The collimated beam then impinges on the first crystal 106 where the two different polarizations are spatially separated into two beams (corresponding to elements a and a′ in the pattern arrangement 140 and pattern arrangement 142, respectively). These beams then travel through the first halfwave plate 108 traversing sub-element a and sub-element a′, which elements are arranged to intercept the separate beams. Since there is no half-waveplate material located in these sub-elements, the two beams undergo no polarization rotation. Subsequently, the two beams pass through the Faraday Rotator element 110 and the second halfwave plate 112, traversing sub-elements a and a′ of pattern arrangements 144 and 146, respectively. In this case, the sub-elements of the pattern arrangements 144 and 146 are arranged in complementary fashion to the sub-element pattern in pattern arrangements 140 and 142. Thus, the sub elements a and a′ contain halfwave plate material, such that the two beams undergo a polarization rotation. Once these shifted beams traverse through second crystal 114, the two beams are recombined and focused on the output fiber 118, as ray 126.

Consider light traveling through the core C2 of the input fiber 102 (corresponding to position b in the pattern arrangements. This path would follow through the GRIN 104 and strike the first crystal 106 where the two polarizations would be spatially separated into two beams whose position in the X-Y plane corresponds to the sub-elements b of pattern arrangement 140 and sub-element b′ of pattern arrangement 142. These two respective beams would then travel through the first halfwave plate 108, traversing sub-elements b and b,′ respectively. Since there is half-waveplate material in these sub-elements, the two beams undergo a rotation. Subsequently, the two rotated beams pass through the Faraday Rotator element 110 and the second halfwave plate 112, traversing sub-elements b and b′ of pattern arrangements 144 and 146, respectively. In this case, the sub-elements of the pattern arrangements 144 and 146 are arranged in complementary fashion to the sub-element pattern in pattern arrangements 140 and 142. Thus, the sub elements b and b′ do not contain halfwave plate material, so that the two beams do not undergo a rotation in second halfwave plate 112. Since the combination of the effects of the halfwave plate and the Faraday Rotator cancel each other, the beams 128 exiting second crystal 114 travel in the same manner as when exiting first crystal 106 (see 120), which circumstance means that the beams are not directed at the corresponding GRIN lens and miss the corresponding output fiber. This result means that light in the core C2 traveling in the same direction as core C1 is prevented from traveling to the right, making the structure into an isolator. Similarly, light in core C2 traveling to the left would be allowed, while light in core C1 traveling to the left is lost (see ray 129).

Note that in the optical isolator 100, the spatial separation of light signals passing through adjacent cores of a multi-core fiber will be increased according to the length of the first crystal 106 along the Z-direction and the relative differences in the extra-ordinary and ordinary index of refraction. The spatial separation of adjacent cores, such as core C1 and C2 may be 50 μm. After passing through the first crystal 106, the separation of different beams may be such that the grid size of the patterning arrangements is much larger, for example, such that the distance between the pattern arrangements 140 and pattern arrangement 142 may be much greater, such as hundreds of micrometers, millimeters, and so forth. It is also possible to have the spatial separation of the polarization components be less than the C1 to C2 distance. However, this latter circumstance presents a more difficult optical design problem. If the separation distance is less than the C1 to C2 distance, then 140 would be the pattern applicable to C1 and 142 would be the pattern applicable to C2.

In view of the above scenario, it may be appreciated that light traveling along a given direction through the optical isolator 100 will be permitted to propagate from an input fiber to an output fiber in a given core and blocked from traveling from that input fiber to the output fiber in an adjacent core. This arrangement allows the isolator to preserve the desired bi-directional functionality of a MCF, while providing isolation from back-reflections. Note that in the embodiment of FIG. 1B a square quadrant pattern for patterned halfwave plates is shown. However, in other embodiments, a polka dot pattern may be used to provide regions of halfwave plate material alternating with regions that do not rotate the light, as shown in the pattern 150 of FIG. 1C.

In additional embodiments of the disclosure, the optical isolator 100 may include other features that render bi-directional operation less susceptible to back-reflections. In one example, an antireflection coating may be arranged on at least one of: the GRIN 104, first crystal 106, the first halfwave plate 108, the Faraday rotator element 110, second GRIN 116, the second crystal 114, and the second halfwave plate 112.

In still other embodiments, a main surface of the following elements may tilted with respect to one another: the GRIN 104, first crystal 106, the first halfwave plate 108, the Faraday rotator element 110, second GRIN 116, the second crystal 114, and the second halfwave plate 112. Accordingly, cross-talk from spurious reflections may be reduced.

In further embodiments, optical power elements may be incorporated in the first halfwave plate 108, the Faraday rotator element 110, and/or the second halfwave plate 112. This optical power may serve as a “field-lens” to help refract the beamlets back towards the ‘output’ GRIN, such as second GRIN 116. This operation may improve the optical efficiency and reduce the insertion loss of the optical isolator.

FIG. 1D depicts an optical isolator 130, according to embodiments of the disclosure. FIG. 1E shows an example of a variant of the optical isolator 130 of FIG. 1D in operation. In this example, the optical isolator 130 may be similar to optical isolator 100, with like parts labeled the same. A difference is that a first linear polarizer 131 and a second linear polarizer 132 are used in lieu of the first crystal 106 and the second crystal 114. This embodiment may be preferable when the input is already polarized or if it is desirable to subpress one polarization. In one example of operation, the input beam (for instance, input light signal 119) would be collimated by the second GRIN 116 lens and then sent into a polarizer (see second linear polarizer 132). If the input is already polarized, no light would be absorbed in second linear polarizer 132. The light would travel through the Faraday rotator element 110 and the patterned structure of first halfwave plate 108, resulting in an output polarization that would pass through the output polarizer (first linear polarizer 131). Backward traveling light from input fiber 102, would be polarized by first linear polarizer 131 and then travel through the first halfwave plate 108 and the Faraday rotator element 110, resulting in light that is orthogonally polarized and therefore blocked by the second linear polarizer 132.

In various embodiments of the disclosure the optical isolator 100, or similar isolators may be incorporated into a fiber amplifier, and in particular, in a multi-core, bi-directional fiber amplifier, including fiber amplifiers used in optical communication systems, particularly subsea optical communication systems. By way of reference, a known single core erbium doped fiber amplifier (EDFA) that has an amplifier fiber may utilize three optical isolators to improve the signal-to-noise ratio (SNR) of the amplifier. For each direction or path of a bi-directional amplifier, these isolators may be positioned in line in an optical path, where a first isolator (input isolator) is located on an input side of a wavelength dependent multiplexer (WDM), which feeds into the doped fiber amplifier. A second isolator may be located between the doped fiber amplifier and a gain flattening filter (GFF), while a third isolator (output isolator) is located on the output side of the GFF. Thus, each path of a bi-directional amplifier may include 3 isolators. In accordance with the present embodiments, a fiber amplifier assembly may incorporate ‘input’ and ‘output’ isolators into a single component. Further, in various non-limiting embodiments, the WDM and GFF may be incorporated into an input/output isolator component. Moreover, in the present embodiments, a single ‘internal’ isolator may be used in lieu of two separate isolators, resulting in a structure that may be constructed entirely out of multi-core fiber.

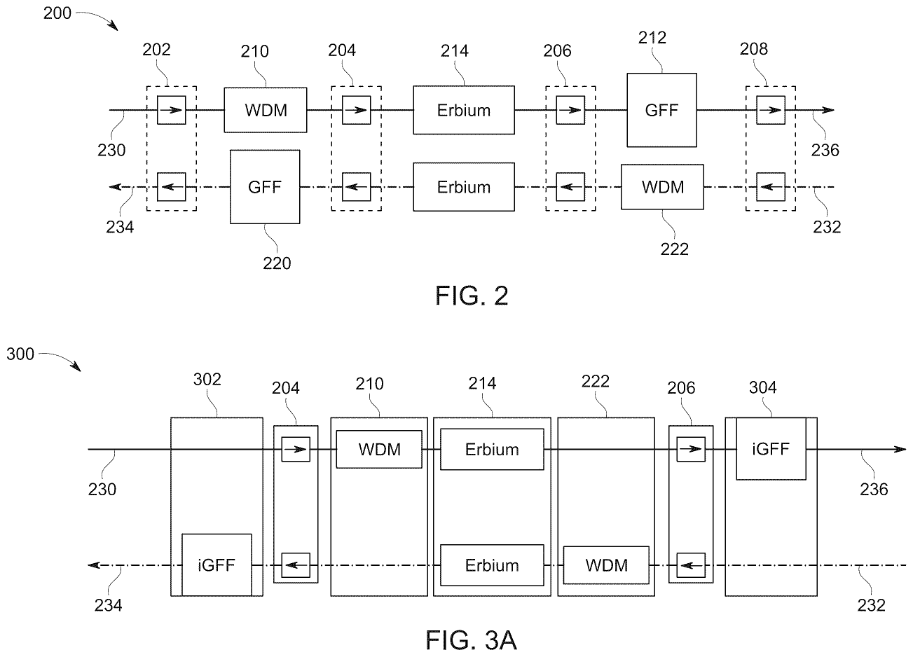

FIG. 2 shows a multicore fiber amplifier assembly, shown as assembly 200, according to embodiments of the disclosure. In this example, assembly 200 may implement bi-directional transmission in the context of a multi-core optical fiber. As an example, a first path is shown from an input end 230 to an output end 236, representing a transmission path for a first core in a multi-core fiber. A second path is shown from an input end 232 to an output end 234, representing a transmission path for a second core in the multi-core fiber. For example, the transmission path from input end 230 to output end 236 may correspond to the core C1 of FIG. 1B, while the transmission path from input end 232 to output end 234 may represent the core C2. In this embodiment, the assembly 200 may include an isolator 202, isolator 204, isolator 206, and isolator 208. Each of the isolators may provide bi-directional protection, as described above with respect to FIG. 1B. In this embodiment, the assembly 200 includes further elements, including a WDM 210, erbium fiber 214 (used to amplify the optical signal), GFF 212, WDM 222, and GFF 220.

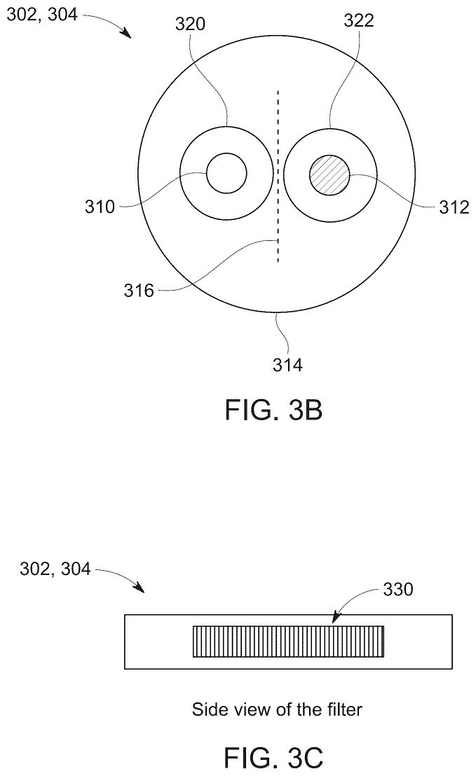

FIG. 3A shows another multicore fiber amplifier assembly, according to embodiments of the disclosure. In this embodiment, the assembly 300 may implement bi-directional transmission in the context of a multi-core fiber, as in the case of assembly 200, with like components labeled the same. In this embodiment, an isolator-GFF component 302 is provided on a first end and an isolator-GFF component 304 provided on a second end, with so separate input/output isolators, as in assembly 200. The isolator-GFFs will prove some amount of isolation so that separate isolators, such as isolators 202, 208, need not be included.

FIG. 3B depicts details of an isolator-GFF component in cross-section. FIG. 3C depicts an isolator-GFF component in side view. The isolator-GFF component 302, 304 is embodied as a multi-core fiber. For purposes of illustration, the multi-core fiber may be formed of a cladding glass matrix 314 that surrounds a pair of cores. An outer jacket (not specifically shown) may surround the cladding glass matrix 314 on an outer surface of the multi-core fiber. A core 310 may be termed an east-bound core, to conduct optical signals (light) for communication in an ‘east-bound’ direction of a bidirectional optical communications system. A core 312 may be termed a west-bound core, to conduct optical signals (light) for communication in a ‘west-bound’ direction of a bidirectional optical communications system. Surrounding the core 310 is a cladding mode suppressing secondary core, shown as secondary core 320, while surrounding the core 312 is a cladding more suppressing secondary core, shown as secondary core 322. Light is coupled into the isolator-GFF component 302, 304 via a Bragg grating 330, as shown in FIG. 3C.

In addition, the multi-core fiber includes a barrier 316, disposed between the core 310 and the core 312. Note that the core 310 may include slanted gratings written into the core 310, so that, in operation, light may enter the Cladding Mode Suppression fiber (CMS) portion associated with core 310, meaning the secondary core 320, and thence enter into the cladding glass matrix 314. The barrier 316 is thus provided in order to prevent light that enters the cladding glass matrix 314 from entering the secondary core 320, associated with the core 310. By providing the barrier 316, the muti-core fiber of IGFFs 302, 304 prevents energy that would otherwise propagate in the same direction as desired information that is carried in the core 310. Thus, the barrier 316 acts to isolate the two core/CMS structures as shown and prevent cross-talk therebetween. In different embodiments, the barrier 316 may be formed as an absorptive layer, or as a hollow region, such as regions of hollow fibers.

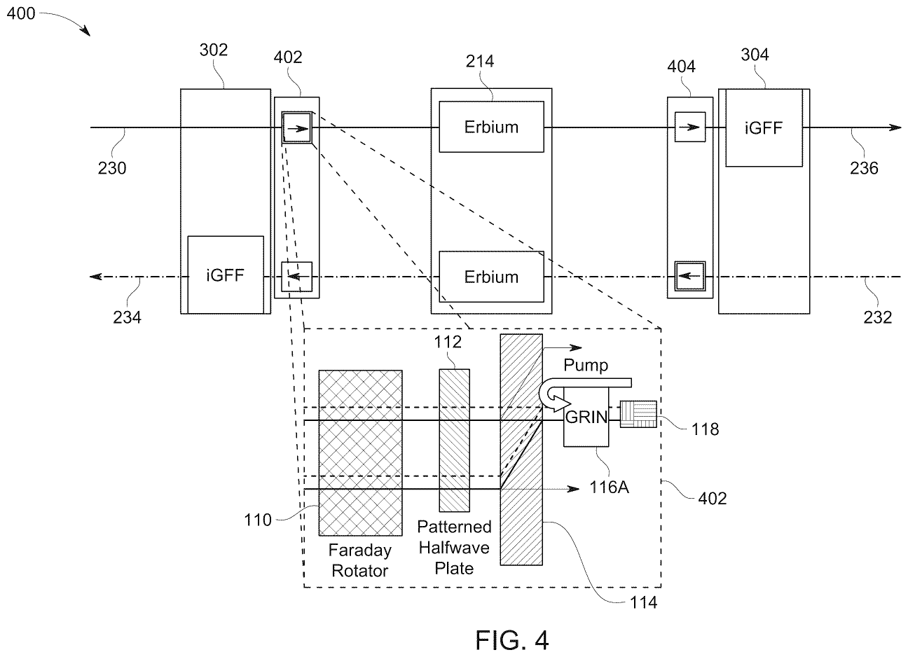

FIG. 4 shows a further multi-core fiber amplifier assembly, according to embodiments of the disclosure. In this embodiment, the assembly 400 may implement bi-directional transmission in the context of a multi-core fiber, as in the case of assembly 200, or assembly 300, with like components labeled the same. Instead of including a separate WDM element, outside of the isolators, in this example, just two isolators are provided, isolator 402 and isolator 404, flanking erbium fiber 214. For both isolator 402 and isolator 404, WDM functionality may be provided by an output face of a birefringent crystal, shown as second crystal 114 in the insert. This output face may insert a reflective wavelength dependent element (WDM) to introduce the pump that is directed toward the respective cores in the erbium fiber 214. Alternatively, the chromatic dispersion of second crystal 114 may be used to introduce the pump from the opposite face (not shown) or depending on the polarization of the pump, the pump could also reflect off second halfwave plate 112.

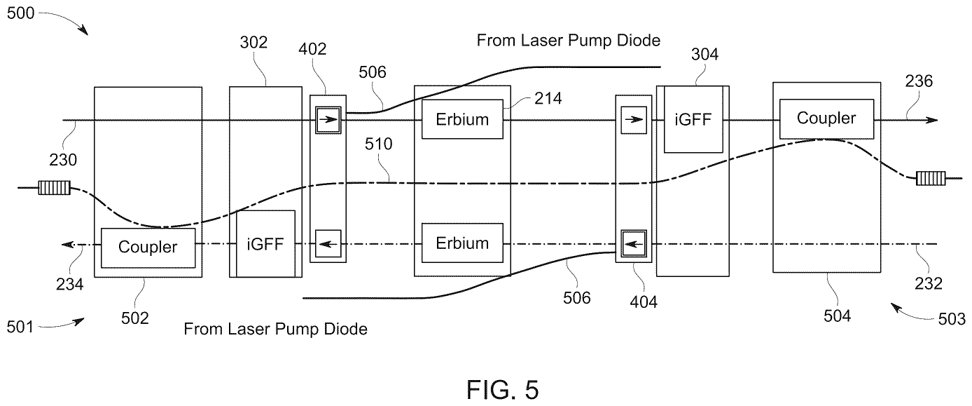

FIG. 5 shows an additional multicore fiber amplifier assembly, according to embodiments of the disclosure. In this embodiment, the assembly 500 may implement bi-directional transmission in the context of a multi-core fiber, as in the case of assembly 200, or assembly 300, or assembly 400, with like components labeled the same. Similar to the embodiment of FIG. 4, in this example, just two isolators are provided, isolator 402 and isolator 404, flanking erbium fiber 214 For both isolator 402 and isolator 404, the laser pump diode to provide pump 506 to the erbium fiber 214 may be provided by direct-write structures that are embedded in the multi-core fiber that extends from first side 501 to the second side 503 of the assembly 500. This implementation may entail locally removing the fiber jacket or using a side polish fiber, for example. This output face may insert a reflective wavelength dependent element (WDM) to introduce the pump that is directed toward the erbium fiber 214. Optionally, a high loss loopback 510 may be provided, which component is coupled between loopback coupler 502 and loopback coupler 504.

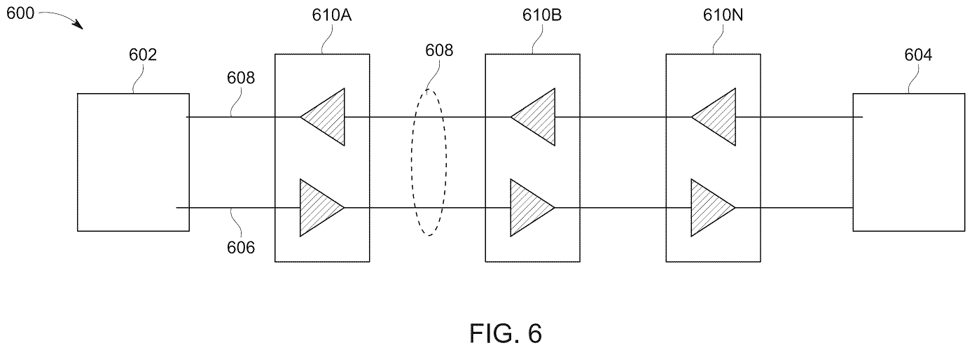

FIG. 6 depicts a communications system, shown as system 600. System 600 may include at least one optical repeater, which repeater may form part of a subsea optical communications system that spans hundreds of kilometers or up to several thousands of kilometers. The system 600 may be employed, at least in part, to conduct bidirectional optical communications through an optical fiber, according to the present embodiments. As shown in FIG. 6, the system 600 includes a pair of terminals that are shown as a first station 602, and a second station 604, where each of these stations may be terrestrial stations, and may be located at opposite ends to the system 600, in order to transmit and receive optical communications over a device, such as a cable. In some variants of the system 600, branching units may be provided, coupled to additional cable(s) that are connected to one or more additional terminals at the terrestrial end of said branching units, as known in the art. Bi-directional data transmission may be implemented by providing pairs of cores in an optical fiber. In the example, shown, an optical fiber 608 may be arranged to conduct signals from ‘west’ to ‘east’ along a signal path 608 formed in a first core, while the optical fiber 608 is further arranged to conduct signals from east to west in a second core (606). A series of optical amplifiers shown as amplifier 610A, amplifier 610B, and amplifier 610N, are arranged along a length of the system 600. The amplifiers 610A, 610B, . . . 610N may be spaced according to a series of spans that may have a length on the order of 50 km, 100 km, or similar distance. In some examples, the number of amplifiers and spans in the system 600 may be on the order of several dozen or more. In various embodiments of the system 600 of FIG. 6, a given amplifier may be a doped fiber amplifier, such as an erbium doped fiber amplifier (EDFA) based upon the multi-core fiber amplifier structure of the preceding embodiments.

### Summary and Advantages

The present embodiments allow bi-directional MCF amplifiers to be made in a manner similar to present day single-core fiber amplifiers. Specifically, it will now be possible to amplify MCF in the same volume as in a single-core fiber system. Thus, a 4-core MCF EDFA requires the same volume as a traditional single core EDFA, leading to a 75% decrease in the overall volume of the amplifier system. This new isolator allows a multi-core EDFA to be built without any FIFO components, thus reducing the number of splices, the number of fibers and the system complexity.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation, in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An optical isolator for a fiber optic system, comprising:
a polarization processing assembly, comprising a first polarization processing element and a second polarization processing element;
a non-reciprocal optical element, disposed between the first polarization processing element and the second polarization processing element; and
a reciprocal optical element assembly, comprising:
a first reciprocal element, disposed between the non-reciprocal optical element and the first polarization processing element;
a second reciprocal element, disposed between the non-reciprocal optical element and the second polarization processing element; and
a patterning element to selectively direct light through the optical isolator according to a polarization of the light.

2. The optical isolator of claim 1, wherein the first reciprocal element and the second reciprocal element comprise a first halfwave plate and a second halfwave plate, respectively, wherein the patterning element is arranged within the first halfwave plate and the second halfwave plate,
wherein the first halfwave plate comprises a first pattern, and
wherein the second halfwave plate comprises a second pattern, the second pattern being complementary to the first pattern.

3. The optical isolator of claim 2, wherein the first halfwave plate comprises a first checkerboard pattern and the second halfwave plate comprises a second checkerboard pattern.

4. The optical isolator of claim 1, further comprising a first gradient index element, wherein the first polarization processing element is disposed between the first gradient index element and the first reciprocal element, and a second gradient index element, wherein the second polarization processing element is disposed between the second gradient index element and the second reciprocal element.

5. The optical isolator of claim 2, wherein the optical isolator is arranged to couple to a multi-core optical fiber having n cores, and wherein the first pattern and the second pattern comprise 2n patterning elements.

6. The optical isolator of claim 4,
wherein the first polarization processing element is a first crystal of a birefringent crystal assembly, and wherein the second polarization processing element is a second crystal of the birefringent crystal assembly, wherein the first reciprocal element and the second reciprocal element comprise a first halfwave plate and a second halfwave plate, respectively,
the optical isolator further comprising an antireflection coating, disposed on at least one of: the first gradient index element, the first crystal, the first halfwave plate, the non-reciprocal optical element, second gradient index element, the second crystal, and the second halfwave plate.

7. The optical isolator of claim 4,
wherein the non-reciprocal optical element is a Faraday rotator element,
wherein the first polarization processing element is a first crystal of a birefringent crystal assembly, and wherein the second polarization processing element is a second crystal of the birefringent crystal assembly, wherein the first reciprocal element and the second reciprocal element comprise a first halfwave plate and a second halfwave plate, respectively,
wherein a main surface of at least two of: the first gradient index element, the first crystal, the first halfwave plate, the Faraday rotator element, second gradient index element, the second crystal, and the second halfwave plate, are tilted with respect to one another.

8. The optical isolator of claim 7, wherein the first reciprocal element and the second reciprocal element comprise a first halfwave plate and a second halfwave plate, respectively, wherein the non-reciprocal optical element is a Faraday rotator element, and wherein optical power is incorporated into at least one of: the Faraday rotator element, the first halfwave plate, the second halfwave plate, or one or more lenses.

9. The optical isolator of claim 1, wherein the first reciprocal element and the second reciprocal element comprise a first halfwave plate and a second halfwave plate, respectively, wherein the patterning element is arranged within the first halfwave plate and the second halfwave plate,
wherein the first halfwave plate comprises a first pattern, and
wherein the second halfwave plate comprises a wavelength filter, arranged to introduce a pump source into an optical path of the optical isolator.

10. The optical isolator of claim 4, wherein the patterning element comprises a gain-flattening filter pattern that is arranged on at least one of: the first gradient index element, and the second gradient index element.

11. A fiber amplifier, comprising:
a pump source, to generate a pump radiation;
a fiber assembly, comprising a first input multi-core fiber and a first output multi-core fiber, disposed along a first optical path, and a second input fiber and a second output fiber, disposed along a second optical path; and
a multi-core fiber amplifier assembly, arranged along the first optical path and the second optical path, and disposed between the first input multi-core fiber and the first output multi-core fiber, and further disposed between the second input fiber and the second output fiber,
the multi-core fiber amplifier assembly comprising a plurality of optical isolators, wherein a given optical isolator of the plurality of optical isolators comprises:
a non-reciprocal optical element;
a first reciprocal element, disposed on a first side of the non-reciprocal optical element;
a second reciprocal element, disposed on a first side of the non-reciprocal optical element; and
a patterning element to selectively direct light through the given optical isolator according to a polarization of the light.

12. The fiber amplifier of claim 11,
wherein the non-reciprocal optical element is a Faraday rotator element,
wherein the first reciprocal element and the second reciprocal element comprise a first halfwave plate and a second halfwave plate, respectively.

13. The fiber amplifier of claim 12, further comprising
a first crystal of a birefringent crystal assembly, wherein the first halfwave plate is disposed between the first crystal and the Faraday rotator element, and
a second crystal of the birefringent crystal assembly, wherein the second halfwave plate is disposed between the second crystal and the Faraday rotator element.

14. The fiber amplifier of claim 11, further comprising:
a first linear polarizer, wherein the first reciprocal element is disposed between the first linear polarizer and the non-reciprocal optical element; and
a second linear polarizer, wherein the second reciprocal element is disposed between the second linear polarizer and the non-reciprocal optical element,
wherein the first input multi-core fiber and a first output multi-core fiber are arranged as polarization preserving fibers.

15. The fiber amplifier of claim 11, the multi-core fiber amplifier assembly comprising:
a first isolator, a second isolator, a third isolator and a fourth isolator, arranged in series;
a first wavelength dependent multiplexer (WDM), arranged along the first optical path between the first isolator and the second isolator;
a second WDM, arranged along the second optical path between the third isolator and the fourth isolator;
a first gain flattening filter (GFF), arranged along the first optical path between the third isolator and the fourth isolator;
a second GFF, arranged along the second optical path between the first isolator and the second isolator; and
an amplifier fiber, disposed between the second isolator and the third isolator.

16. The fiber amplifier of claim 11, the multi-core fiber amplifier assembly comprising:
a first isolator, a second isolator, a third isolator and a fourth isolator, arranged in series;
an amplifier fiber, disposed between the second isolator and the third isolator;
a first wavelength dependent multiplexer (WDM), arranged along the first optical path between the second isolator and the amplifier fiber;
a second WDM, arranged along the second optical path between the third isolator and the amplifier fiber;
a first gain flattening filter (GFF), arranged along the first optical path between the third isolator and the fourth isolator; and
a second GFF, arranged along the second optical path between the first isolator and the second isolator.

17. The fiber amplifier of claim 11, the multi-core fiber amplifier assembly comprising:
a first isolator, a second isolator, a third isolator and a fourth isolator, arranged in series;
an amplifier fiber, disposed between the second isolator and the third isolator;
a first gain flattening filter (GFF), arranged along the first optical path between the third isolator and the fourth isolator;
a second GFF, arranged along the second optical path between the first isolator and the second isolator;
a first loopback coupler, arranged along the first optical path, wherein the fourth isolator is arranged between the first loopback coupler and the first GFF; and
a second loopback coupler, arranged along the second optical path, wherein the first isolator is arranged between the second loopback coupler and the second GFF;
wherein the second isolator is coupled to the pump source, and wherein the third isolator is coupled to the pump source.

18. The fiber amplifier of claim 11, the multi-core fiber amplifier assembly comprising:
a first isolator, and a second isolator, arranged in series;
an amplifier fiber, disposed between the first isolator and the second isolator;
a first wavelength dependent multiplexer (WDM), arranged along the first optical path between the first isolator and the amplifier fiber;
a second wavelength dependent multiplexer (WDM), arranged along the first optical path between the second isolator and the amplifier fiber;
a first isolator-gain flattening filter (iGFF), wherein the first isolator is disposed between the first isolator-gain flattening filter and the amplifier fiber; and
a second iGFF, wherein the second isolator is disposed between the second iGFF and the amplifier fiber.

19. The fiber amplifier of claim 18, the first IGFF and the second iGFF comprise a first multi-core fiber and a second multi-core fiber, wherein a given multi-core fiber of the first multi-core fiber and the second multi-core fiber comprises:
a first core, for carrying traffic along the first optical path;
a second core, for carrying traffic along the second optical path; and
a barrier, disposed between the first core and the second core.

20. The fiber amplifier of claim 11, comprising a wavelength dependent element to couple in the pump radiation to a non-reciprocal element, a reciprocal element, or a GRIN of the given optical isolator.
